(19) United States
(12) Patent Application Publication
(10) Pub. No.: US 2014/0213374 A1
(43) Pub. Date: Jul. 31, 2014

(54) HIGH ANGLE CONSTANT VELOCITY JOINT AND BOOT

(71) Applicants: Robert Leslie Cassell, Lake Orion, MI (US); Michael James Miller, White Lake, MI (US); Sam Junior D'Angelo, Royal Oak, MI (US); Hans Wormsbaecher, Lake Orion, MI (US)

(72) Inventors: Robert Leslie Cassell, Lake Orion, MI (US); Michael James Miller, White Lake, MI (US); Sam Junior D'Angelo, Royal Oak, MI (US); Hans Wormsbaecher, Lake Orion, MI (US)

(21) Appl. No.: 14/343,443

(22) PCT Filed: Sep. 23, 2011
(86) PCT No.: PCT/US11/52887

§ 371 Date: Mar. 7, 2014

(51) Int. Cl. F16D 3/24

(52) U.S. Cl. CPC F16D 3/24
USPC 464/145

(57) ABSTRACT

A high angle constant velocity joint having an outer joint member defined by inner and outer surfaces; an inner joint member having an outer surface, wherein the inner surface of the outer joint member and the outer surface of the inner joint define tracks, including a front track and a rear track for a joint articulation; a cage disposed between the outer joint member and the inner joint member and positioned adjacent to the tracks; a plurality of torque transmitting bails arranged within the cage and contacting at least one of the front track and the rear track; and a high angle sealing member secured to the outer surface of the outer joint member and providing a fluid barrier to the inner surface of the outer joint member.

### TECHNICAL FIELD

The disclosure generally relates to constant velocity joints and more particularly, to high angle, high-speed constant velocity joints and protective high angle joint boots.

### BACKGROUND ART

Articulating joints are common components in all types of automotive vehicles. Articulating joints are typically used where transmission of rotary motion is desired or required. In other words, articulating joints operate to transmit torque between two rotational members. The rotational members are typically interconnected by a cage or yoke that allow operation at relative angles and are typically sealed by a boot cover assembly. The joints typically connect shafts to drive units, which characteristically have an output shaft or an input shaft for receiving the joint. The drive unit may be an axle, transfer case, transmission, power take-off unit, or other torque transmitting device, all of which are common components in automotive vehicles.

Common types of articulating joints include but are not limited to, double cardan joint, a plunging tripod constant velocity (CV) joint, a fixed tripod CV joint, a plunging ball CV joint, and a fixed ball CV joint. These joints can be used in a variety of different configurations, including four wheel drive vehicles, all wheel drive vehicles, front wheel drive vehicles or rear wheel drive vehicles. Single or double cardan joints are typically used where high driveline operating angles over 8° are encountered. Double cardan joints are typically used to remove vibration and joint bind found in high angle drivelines using a single universal joint. A double cardan joint configuration uses two universal joints joined back to back, which cancels any velocity error that may be introduced by a single joint and functions similarly to a constant velocity joint. However, the cardan joint is heavy and adds greater weight to the driveline.

Constant velocity joints are commonly classified by their operating characteristics. One important operating characteristic relates to the relative angular velocities of the two shafts connected thereby. In a constant velocity joint, the instantaneous angular velocities of the two shafts are always equal, regardless of the relative angular orientation between the two shafts. In a non-constant velocity joint the instantaneous angular velocities of the two shafts vary with the angular orientation (although the average angular velocities for a complete rotation are equal). Another important operating characteristic of the constant velocity joint is the ability of the joint to provide similar articulation between the two shafts, as does the cardan joint, while eliminating driveline vibrations and weight savings.

Unlike cardan joints, all of these constant velocity joints are generally grease lubricated for life and sealed by a sealing boot when used on drive members. Thus, the constant velocity joints are sealed in order to retain grease inside the joint while keeping contaminants and foreign matter, such as dirt and water, out of the joint. The sealing protection of the constant velocity joint is necessary, because contamination of the inner chamber may cause internal damage and destruction of the joint, which increases heat and wear on the boot, inevitably leading to premature boot and grease failures and failure of the overall joint. The problem of higher temperatures in high speed constant velocity joint is also greatly enhanced at the higher angles. Thus, the increased temperatures because of the higher angles, along with increased stresses on the boot caused by higher angles, may result in premature failures of the prior art constant velocity joints.

In a typical prior art constant velocity joint, a bulky and heavy outer race is used, having a spherical inner surface and a plurality of grooves on a surface therein. The joints also include an inner race, having a spherical outer surface with guide grooves formed therein. The prior art constant velocity joints use six torque transmitting balls, which are arranged between the guide grooves and the outer and inner race surfaces of the constant velocity joint by a cage retainer. The balls allow a predetermined displacement angle to occur through the joint thus, transmitting a constant velocity through the shafts of the automotive drive train system. The standard fixed high angle and high-speed constant velocity joints have limitations to operational articulation clearance between the shaft and the boot, as well as similar assembly angle limitations, while the double cardan joints are bulky, require greater maintenance due to the lack of a sealing boot, and are typically inefficient as compared to a true constant velocity joint. However, the use of a constant velocity joint requires a resilient and robust sealing system that can handle the high angle up and down excursions in conjunction with the rotational speeds required for propshafts, which are typically in the range of 3500 RPMs to 8000 RPMs. These limitations result in premature failure of the joints due to lack of a sealing boot and damage to the sealing boot from contact between the joint and boot during full suspension jounce articulation.

Therefore, there is a need in the art for a joint that is lighter, efficient and more robust than a typical cardan joint or a standard constant velocity joint. There is also a need in the art for a constant velocity joint sealing system that is capable of having greater articulation during installation, while providing greater operating articulation and resistivity to boot and joint damage during full suspension jounce articulation.

### BRIEF DESCRIPTION OF DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is a top view of an exemplary driveline system;

FIG. 2 is a view of an exemplary propshaft;

FIG. 3 is a section view of an exemplary high angle constant velocity joint;

FIG. 4 is a section view of an exemplary high angle constant velocity joint and outwardly flared sealing member;

FIG. 5 is an isometric view of an exemplary high angle constant velocity joint sealing member;

FIG. 6 is a section view of an exemplary high angle constant velocity joint sealing member;

FIG. 7 is a section view of an exemplary high angle constant velocity joint inwardly flared sealing member;

FIG. 8 is a section view illustrating an exemplary high angle constant velocity joint assembly demonstrating the shaft, shown in phantom, at a 15° running angle and a 26° jounce angle

FIG. 9 is a section view illustrating an exemplary high angle constant velocity joint assembly demonstrating the shaft, shown in phantom, at a 15° running angle and a 26° jounce angle

FIG. 10A is a partial section view of an exemplary high angle constant velocity joint sealing member articulated at the 15° running angle;

FIG. 10B is a partial section view of the exemplary high angle constant velocity joint sealing member of FIG. 10A, with the sealing member bottom section compressed;

FIG. 10C is a partial section view of the exemplary high angle constant velocity joint sealing member of FIG. 10A, with the sealing member top section extended;

FIG. 11A is a partial section view of an exemplary high angle constant velocity joint inwardly flared sealing member articulated at the 15° running angle; and

FIG. 11B is a partial section view of the exemplary high angle constant velocity joint inwardly flared sealing member of FIG. 11A, with the sealing member bottom section compressed.

### DETAILED DESCRIPTION

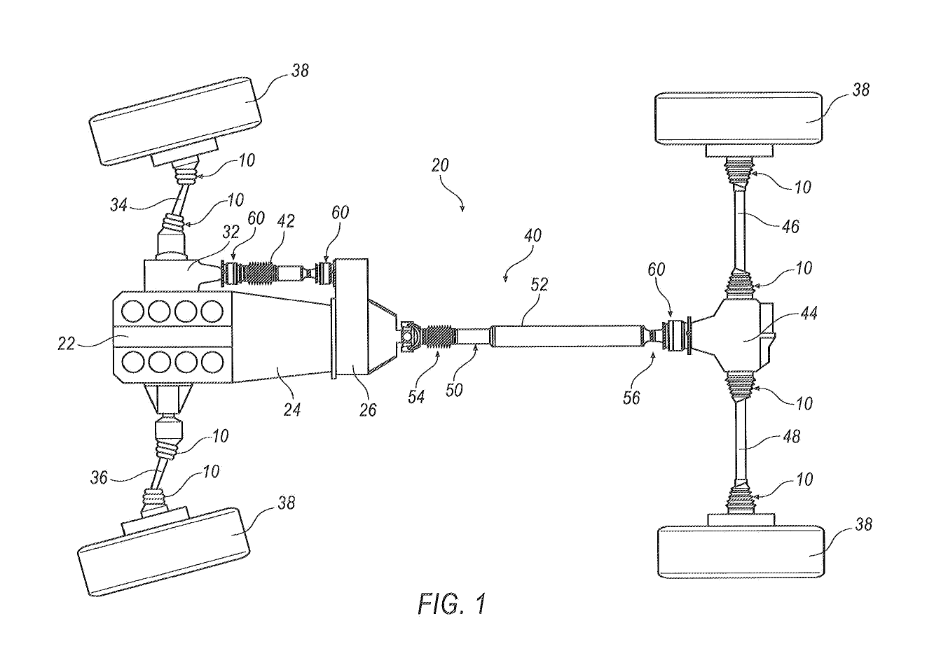

Referring to the drawings and FIG. 1, an exemplary driveline arrangement including constant velocity joints 10 is shown. Some constant velocity joints 10 are generally configured as a high angle, high speed, ball type constant velocity joint for use on propeller shafts, drive shafts or connected directly to a drive unit. Generally, the high angle of the high angle constant velocity joint 60 can be defined as a constant velocity joint operating at an approximate 10° operating angle. The operating angles of the exemplary embodiments described below is in the range of approximately 0° to 30° with a continuous operating angle range of approximately 12° to 18°, a jounce angle range of approximately 15° to 30°, and an installation angle range of approximately 0° to 35°.

A typical driveline for a vehicle includes a plurality of constant velocity joints 10 with at least one constant velocity joint being a high angle constant velocity joint 60. However, it should be noted that the constant velocity joint disclosed herein can be used in rear wheel drive only vehicles, front wheel drive only vehicles, all wheel drive vehicles and four wheel drive vehicles. Generally, a driveline includes an engine that is connected to a transmission and a power take-off unit or transfer case interconnected to at least one differential. A front differential may have a right hand side shaft and a left hand side shaft, each of which are connected to a wheel and deliver power to the wheels. On both ends of the right hand front side shaft and left hand front side shaft are constant velocity joints. A propeller shaft connects the front differential and the rear differential to the transfer case or power take-off unit. The rear differential may include a right hand rear side shaft and a left hand rear side shaft, each of which ends with a wheel on an end thereof. Generally, a constant velocity joint is located on both ends of the side shaft that connect to the wheel and the rear differential. The propeller shaft generally may be a multi-piece propeller shaft that includes a plurality of joints, specifically high speed constant velocity joints. Typically, at least one of the joints on the propeller shaft may be a high angle high speed constant velocity joint (HACVJ) 60. The HACVJ 60 transmits power to the wheels through the drive shaft even if the wheels or the shaft have changing angles due to steering, raising or lowering of the suspension of the vehicle, etc. The HACVJ 60 allows for transmission of constant velocities at a variety of angles, which are found in everyday driving of automotive vehicles on both the half shafts and prop shafts of these vehicles. The high angle movement feature enables the shaft to articulate at greater operating angles above 10° and full suspension jounce articulation angle above 15° without damaging the constant velocity joint assembly during various suspension angle changes in the drive line.

FIG. 1 illustrates an exemplary driveline 20 of a vehicle (not shown). The driveline 20 may include an engine 22 that may be connected to a transmission 24 and a transfer case, also known as a power take-off unit 26. A front differential 32 may have a right hand front side shaft 34 and a left hand front side shaft 36, each of which may be connected to a wheel 38 and may deliver power to those wheels 38. The power take-off unit 26 may have a main propeller shaft 40 and a front wheel propeller shaft 42 extending therefrom. The front wheel propeller shaft 42 may connect the front differential 32 to the power take-off unit 26 for transmitting torque. The propeller shaft 40 may connect the power take-off unit 26 to transmit a rotational torque to a rear differential 44. The rear differential 44 may include a rear right hand side shaft 46 and a rear left hand side shaft 48, each of which ends with a wheel 38 on one end thereof.

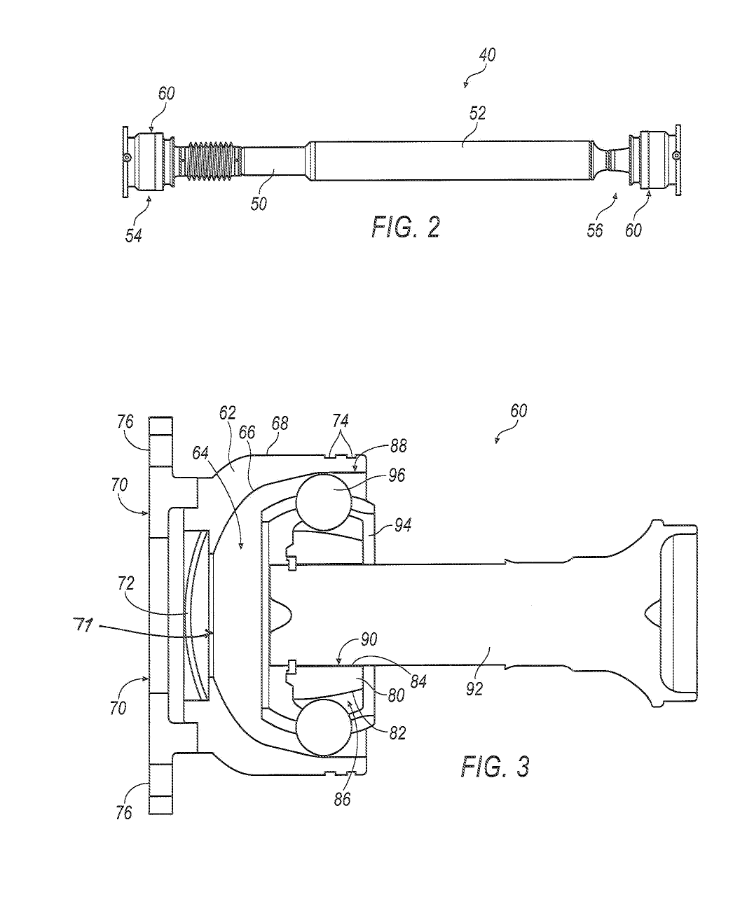

FIG. 2 illustrates an exemplary propeller shaft 40 with two high angle constant velocity joints 60 attached at a first end 54 and a second end 56, respectively. The propeller shaft 40 may include a front prop shaft portion 50 and a rear prop shaft portion 52, and may be constructed in any one of multiple configurations, such as, but not limited to, a single piece shaft, a two piece shaft, a two piece telescoping shaft, a three piece shaft or any other known shaft configuration. The front propeller shaft 42, illustrated in FIG. 1, may be of similar construction as the propeller shaft 40 and is not limited to one particular configuration. However, depending on the application, the front propeller shaft 42 may be a smaller axial length as compared to the propeller shaft 40, due to a shorter axial length between the power take-off unit 26 and the front differential 32, illustrated in FIG. 1. The propeller shafts 40, 42 may be constructed from a variety of torque transmitting materials, such as, but not limited to steel, aluminum and composite (carbon fiber or known carbon metal matrix materials).

FIGS. 3 through 13B illustrate exemplary arrangements of high angle high speed constant velocity joints (HACVJ) 60. The HACVJ 60 is generally shown in FIGS. 3, 4, 8 and 9. FIG. 3 is a cross-sectional view of an exemplary HACVJ 60, which includes an outer race 62 generally having a circumferentially shaped cavity 64. The cavity 64 is defined by an outer race inner surface 66 and an outer surface 68. However, the outer race 62 circumferentially shaped cavity 64 may alternatively be in the shape of a bore or aperture 71 extending therethrough. This bore or aperture 64 may provide the outer race 62 with a ring like shape or appearance. When the ring like shape is used, an additional sealing cap 72 is required to seal the cavity for retaining a lubricant.

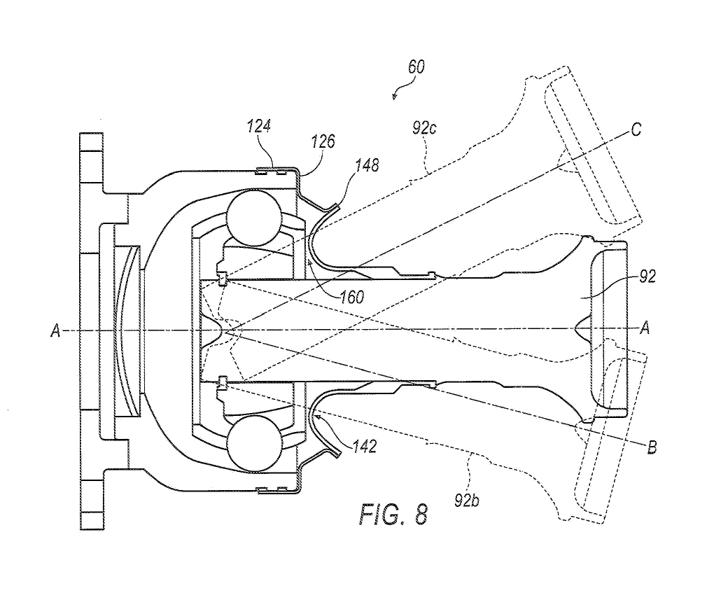

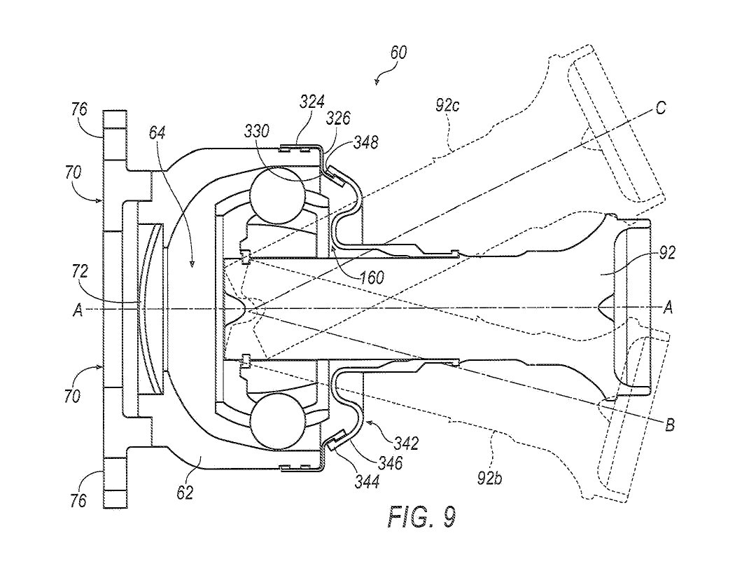

Positioned within the circumferentially shaped cavity 64 is an inner race 80. The inner race 80 includes an outer surface 82 and an inner surface 84. The inner race outer surface 82 includes a plurality of indentations or tracks 86 that correspond to a plurality of indentations or tracks 88 positioned in the inner surface 66 of the outer race 62. When inner race 80 is positioned with outer race 62, the tracks 86, 88 create channels for receiving a plurality of torque transmitting balls 96 that are retained within a cage 94. The tracks 86, 88 may be counter tracks where a first channel set may open towards the aperture 71 and a second channel set may open away from the aperture 71. The first set of channels may be spaced an equidistance with every other channel being a first channel or front track with the other channel being the second channel or rear track. A rotation of the outer race 62 will rotate the inner race 80 at the same or constant speed thus allowing for constant velocity to flow through the joint 60 in a straight line or through an angle up to a predetermined fixed angle (See FIGS. 8 and 9). The cage 94 has clearance for receiving the balls 96 and is positioned between the inner race 80 and the outer race 62.

Additionally, the tracks 86, 88 may include the first front track and the second rear track. The front track may extend a length range of approximately 18.5 mm to approximately 22.5 mm and have a front track wrap angle ratio range of approximately 16° to approximately 19.5° with a front track length and front wrap angle ratio increase of approximately 19.8% over previous designs. The rear track may extend a length range of approximately 30 mm to approximately 34 mm and have an approximate rear track wrap angle ratio range of approximately 30° to approximately 34° with a rear track length ratio increase of 6.8% over previous designs and a rear wrap angle ratio increase of approximately 6.5% over previous designs. The wrap angle may be the angle range in which the torque transmitting ball 96 is surrounded by the associated channel. The front and rear track lengths and the front and rear track wrap angle ratios provide a path allowing the torque transmitting balls 96 to rotate and extend or rotatively travel in opposite directions while providing proper strength and support through the wrap angle ratios described above. This rotational travel allows the HACVJ 60 inner race 80 to articulate and move relative to the outer race 62 as the torque transmitting balls 96 roll within the tracks 86, 88. This rolling motion is a function of clearance provided by the relationship of the tracks 86, 88, which aids in keeping the balls from sliding and eliminates any added friction when the balls do not roll. The track length and the track wrap angle ratios provide the basis for allowing the HACVJ 60 to articulate at such high angles without placing the joint in bind or allowing the balls to extend outside the circumferentially shaped cavity 64, which would result in HACVJ 60 failure.

As illustrated, the inner surface 84 may define a generally cylindrical through aperture 90 for receiving a shaft 92. However, depending on the application, the inner race 80 may also be formed with an integral shaft 92. The shaft 92 connects the HACVJ 60 to at least one of the propeller shafts 40, 42, the differentials 32, 44, or the power take-off unit 26. The outer race 62 and inner race 80 are generally made of a steel material; however it should be noted that any other type of metal material, hard ceramic, plastic, polymer or composite material, etc. may also be used for the outer 62 and inner 80 races. The material is required to be able to withstand the high speeds, temperatures and contact pressures of the HACVJ 60. As illustrated, the outer race 62 generally extends into a mounting flange 70. Additionally, the circumferentially shaped cavity 64 may also include the sealing cap 72, which may be used to minimize the amount of open space available within the cavity 64. The minimized space may help to reduce the volume of lubricant required for the HACVJ 60.

Depending on the application, the outer race 62 may include a variety of mounting options for securing the HACVJ 60 to the propeller shaft 40, 42 or other torque transmitting member. The mounting options may include mechanical securing elements, such as, but not limited to, welding, bolting, splines, plug-on, plug-in, tube mounted, companion flange, fusing, chemically bonding, polymers or other known mount techniques that are integrated into the HACVJ 60. Accordingly, the shape of the end of the outer race 62 may be dependent on the type of mechanical securement that is required. As illustrated, the HACVJ 60 includes the mounting flange 70 for affixing the HACVJ 60 to one of the components of the driveline 20. To facilitate the mechanical securement when using the flange includes the use of a plurality of mounting orifices 76 that may be located around and extend through an outer periphery of the mounting flange 70 for receiving bolts (not shown). The mounting orifices 76 may be arranged equidistant from one another and may be organized depending on the application and driveline 20 component that the flange 70 is mounted.

On the outer surface 68 of the HACVJ 60, at least one circumferential channel 74 may be located. The channel 74 may provide a surface for engaging a first member 122 of a sealing member 120, as discussed in greater detail below. As illustrated, HACVJ 60 includes two channels 74 that extend circumferentially around the outer surface 68 for engaging the first member 122. Additionally, the channel 74 may extend around the entire outer periphery of the outer surface 68 and allows for the placement of a sealing o-ring (not shown) for sealing the lubricant within the sealing member 120 to create a fluid barrier.

As discussed above, the sealing member 120 may be affixed to the HACVJ 60 at the channel 74. The sealing member 120 includes the first member 122 and a second substantially flexible member 142 secured to the first member 122. The first member 122 may be at least one of flexible or rigid depending on the application. As illustrated, the first member 122 is formed of a generally rigid material, such as, but not limited to steel, aluminum, polymer, composite or composite metal matrix materials. The flexible member 142 is a generally pliable material for allowing expansion and contraction of the flexible member. The first member 122 may be formed as a continuous stepped ring, depending on the application.

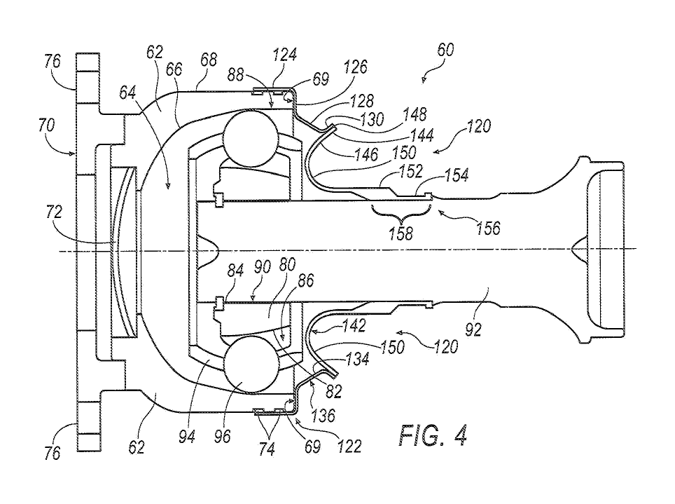

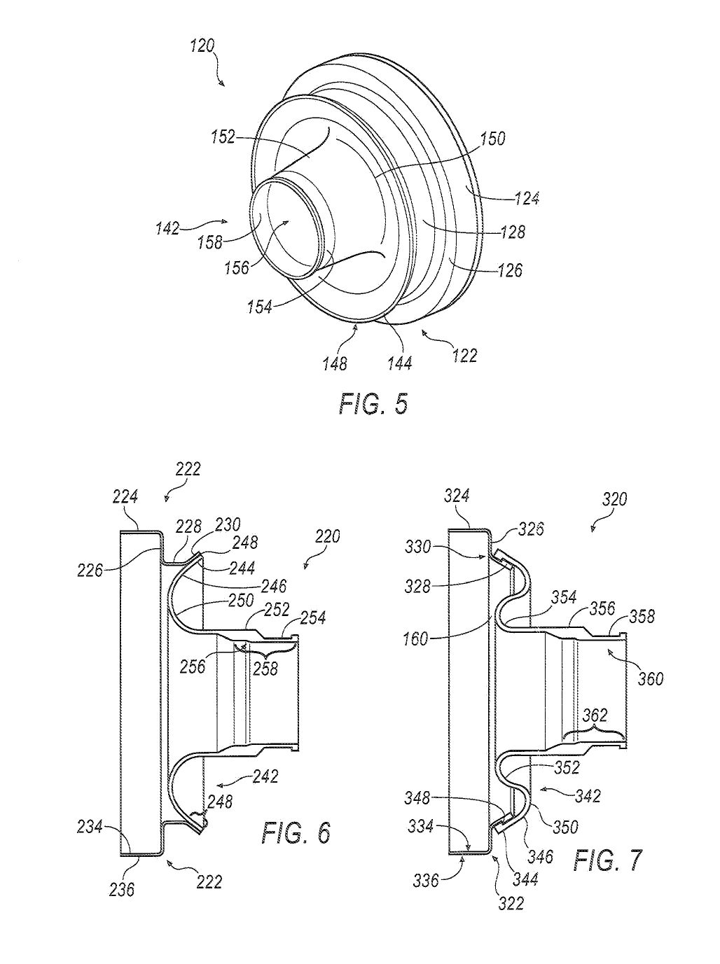

Specifically, in one exemplary arrangement, the first member 122 has an inner surface 134 and an outer surface 136. The inner surface 134 may directly contact the HACVJ 60 while the outer 136 surface may be directly in contact with the environment. The first member 122 may be constructed having a contacting surface that may follow the outer contour of outer surface 68 of the HACVJ 60. However, the shape of the first member 122 is dependent upon the joint with which the sealing member 120 is used. The first member 122 may be contoured with a slightly smaller diameter as compared to the outer surface 68 for a press fit. Additionally, a lip (not shown) may be contoured about the first member 122 for engaging the channel 74 such that the first member 122 may be removably attached directly to the HACVJ 60. As illustrated in FIGS. 4 and 5, the first member 122 may include a first section surface 124 that extends parallel with the outer surface 68 of the HACVJ 60. The first member 122 may extend to a second section surface 126 that follows and directly contacts the outer surface 68 front face 69 of the HACVJ 60. It should be known that the second section surface 126 extends over the front face 69 a predetermined distance, which allows the surface 126 to be used as a positive stop. The positive stop may prevent over-articulation of the torque transmitting balls 96 and retain the balls within the HACVJ 60.

As illustrated in one exemplary arrangement, the first member 122 extends to a generally inwardly angled section 128 and terminates at a generally outwardly flared section 130 where the first member 122 connects to the flexible member 142. The first member 122 may be physically and/or chemically bonded to the flexible member 142 using any brown process for adhering a rubber, a composite, or other known flexible materials to a rigid, semi-rigid or flexible object. Generally, the flexible member 142 may be molded directly to the first member 122 during production of the flexible member 142. However, it some applications the first member 122 and the flexible member 142 may be made of a continuous piece.

The flexible member 142 may be an internal rolling diaphragm (IRD) member, which may be shaped in the form of a concave arc. However, other types of flexible members 242, 342, illustrated in FIGS. 6 and 7, may be used depending on the application, which will be discussed in greater detail below. The flexible member 142 includes a first end 144, a downwardly extending transition portion 146 extending to an arced concave portion 150, and a second transition portion 152 ultimately terminating at a second end 154. In one exemplary arrangement, the first end 144 may be bonded directly to the first member 122 at a coupling region 148, as previously discussed, while the second end 154 may be secured to the shaft 92. Generally, first end 144 and concave portion 150 may be of a uniform thickness, while the second transition portion 152 and second end 154 may be of varied thickness. However, as illustrated, the varied thickness at the second transition portion 152 and at the second end 154 provides a substantially rigid area 156 that is used to create a sealing portion 158. The rigid area 156 of sealing portion 158 is used to seal and secure the flexible member 142 to the shaft 92. Generally, a strap or clamp (not shown) is used to tighten the flexible member 142 to the shaft 92. The strap may be a thin metallic or plastic/composite band that is extended around the flexible member 142 and tightened to form a seal or fluid barrier between the flexible member 142 and the shaft 92 to prevent debris from entering and lubricant from escaping the HACVJ 60.

As discussed above, the first member 122 and the flexible member 142 may be of varied configurations depending on the joint that is being mated with the sealing member 120. FIGS. 6 and 7 illustrate additional exemplary embodiments that may be used with the HACVJ 60. Specifically, FIG. 6 illustrates one exemplary arrangement of a sealing member 220 that includes a first member 222 and a substantially flexible member 242 molded to the first member 222 at a coupling region 248. The first member 222 may be formed of a generally rigid material, such as, but not limited to, steel, aluminum, polymer, composite or composite metal matrix materials. The flexible member 242 is a generally pliable material for allowing expansion and contraction of the flexible member. The first member 222 may be formed as a continuous stepped ring.

The first member 222, as illustrated in FIG. 6, is substantially rigid and has an inner surface 234 and an outer surface 236. The inner surface 234 may directly contact the HACVJ 60, while the outer 236 surface may be directly in contact with the environment. The first member 222 may be constructed having the inner contacting surface 234 that may conform to the outer contour of the outer surface 68 on the HACVJ 60. However, as previously discussed, the shape of the first member 222 is dependent upon the joint with which the sealing member 120 is used.

As illustrated in FIG. 6, the first member 222 may include a first section surface 224 that extends parallel with the outer surface 68. The first member 222 may extend to a second surface 226 that follows the outer surface 68 front face 69 contour of the HACVJ 60.

The first member 222 extends generally longitudinally to second section 228 and terminates at an outwardly flared section 230 where the first member 222 connects with the flexible member 242 and forms the coupling region 248. The first member 222 may be coupled with the flexible member 242 by physically and/or chemically bonding the members 222, 242 together using any known process for adhering a rubber, a composite, or other known bonding processes. The members 222, 242 may also be coupled together using any known mechanical fastener. In one exemplary arrangement, the flexible member 242 is molded directly to the first member 222 during production of the flexible member 242. Merely by way of example, if the molding process is used to couple the two separate members 222, 242, together, the first member 222 is generally produced first, and a polymer, activating element, composite, activating catalyst or adhesive (not shown) is applied to the coupling region 248 of first member 222 and placed into a mold then the flexible member 242 is molded around and fused to the first member 222 at the coupling region 248. The molding process may be generally referred to as an overmolding process where at least one previously molded part is inserted into a mold and a new layer of plastic is formed around the existing part. The process generally utilizes high heat and pressure to activate a chemical reaction between the polymer, activating element and composite activating catalyst or adhesive fuse together the first flexible member and the substantially flexible member to create an exemplary arrangement of a sealing member 220.

Like the previously discussed flexible member 142, flexible member 242 may be an internal rolling diaphragm (IRD) member, which may be shaped in the form of a concave arc. The flexible member 242 includes a first end 244, a downwardly extending transition portion 246 extending to an arced concave portion 250, and a second transition portion 252 ultimately terminating at a second end 254. The first end 244 may be bonded directly to the first member 222 at a coupling region 248, as previously discussed, while the second end 254 may be secured to the shaft 92. Generally, the first end 244 and concave portion 250 may be of a uniform thickness, while the second transition portion 252 and second end 254 may be of varied thickness. However, as illustrated, the varied thickness at the second transition portion 252 and at the second end 254 provides a substantially rigid area 256 that is used to create a sealing portion 258. The rigid area 256 of sealing portion 258 is used to seal and secure the flexible member 242 to the shaft 92.

Turning to FIG. 7, a sealing member 320 is illustrated that includes a first member 322 and a substantially flexible member 342 molded to the first member 322 at a coupling region 348. As illustrated, the first member 322 is substantially rigid and the members 322 and 342 are constructed of two separate elements. The first member 322 may be formed of a generally rigid material, such as, but not limited to, steel, aluminum, polymer, composite or composite metal matrix materials. The flexible member 342 is a generally pliable material for allowing expansion and contraction of the flexible member 342. The first member 322 may be formed as a continuous stepped ring depending on the requirements.

The first member 322, as illustrated in FIG. 7, has an inner surface 334 and an outer surface 336. The inner surface 334 may directly contact the HACVJ 60 while the outer 336 surface may be directly in contact with the environment. The first member 322 may be constructed having the inner contacting surface 334 conform to the outer contour of the outer surface 68 of the HACVJ 60. However, as previously discussed, the shape of the first member 322 is dependent upon the joint with which the sealing member 320 is used.

As illustrated in FIG. 7, the first member 322 may include a first surface 324 that extends parallel with the outer surface 68 of the HACVJ 60. The first member 322 may extend longitudinally to a right angle, which extends to a second surface 326 that is generally perpendicular to the first surface 324 extending parallel to the front face 69 and also continues to follow the outer surface 68 contour of the HACVJ 60. The first member 322 transitions to, and terminates at, an inwardly flared extension 328 where the first member 322 connects with the flexible member 342 and forms the coupling region 348. The rigid member 322 may be physically and/or chemically bonded to the flexible member 342 using any known process for adhering a rubber, a composite, or other known flexible materials to a rigid object. Generally, the flexible member 342 is molded directly to the rigid member 322 during production of the flexible member 342. Additionally, the rigid member 322 may include an angle stop 330. The angle stop 330 will stop the torque transmitting balls from over articulating and possibly destroying the flexible member 332. The angle stop 330 may also be used in any of the exemplary embodiments disclosed above, and merely by way of example, is illustrated in FIG. 7 at the transition between the second surface 326 and the inwardly flared extension 328.

As illustrated, flexible member 342 is generally “S” shaped and includes a first end 344, an upwardly extending first transition portion 346 extending to an arced convex portion 350, a downwardly extending second transition portion 352 extending to an arced concave portion 354, and an upwardly extending third transition portion 356 that ultimately terminates at a second end 358 adjacent the shaft 92. The first end 344 may be bonded directly to the rigid member 322 at a coupling region 348, as previously discussed, while the second end 358 may be secured to the shaft 92. Generally, the first end 344, first transition portion 346, arced convex portion 350, second transition portion 352 and arced concave portion 354 may be of a uniform thickness, while the third transition portion 356 and second end 358 may be of varied thickness. However, as illustrated, the varied thickness at the third transition portion 356 and at the second end 358 provides a substantially rigid area 360 that is used to create a sealing portion 362. The rigid area 360 sealing portion 362 is used to seal and secure the flexible member 342 to the shaft 92. The exemplary sealing members 220 and 320 illustrated in FIGS. 6 and 7 both utilize the same type of strap or clamp as the previously discussed with sealing member 120.

Turning to FIGS. 8-11B, exemplary HACVJ 60 and sealing members 120 and 320 are illustrated joined together to form an HACVJ 60 assembly during articulation. Specifically, the FIGS. illustrate the use of sealing members 120, 320 with the shaft 92 at a 0° angle. In operation, the HACVJ 60 assembly may articulate and rotate at a range of 0° to approximately 30°. As illustrated in phantom in FIGS. 8 and 9, shaft 92B is positioned at a continuous 15° down angle with shaft 92C being illustrated with a 26° extended jounce angle. In operation the shaft is able to articulate and rotate at the specified range without creating damage to the flexible members 142, 342. The illustrations clearly demonstrate clearance around the shaft 92, 92B, 92C without interference by the sealing members 120, 320. Additionally, when the sealing members 120, 220 and 320 are installed on the HACVJ 60, there is a minimum clearance 160 between the apex of the arced concave portion 142, 242, 354 and at least one of the cage 94, torque transmitting balls 96 and inner race 80. Generally, the clearance 160 may be in the range of approximately 1 mm to 3 mm with a target of approximately 1.95 mm, depending on the application. The clearance 160 may be a product of the placement of the sealing member 120, 220 and 320 directly adjacent the cage 94 at an approximate distance of 65 mm from the second end 56 of the shaft 52 or 69 mm from the second end 56 of the shaft 52.

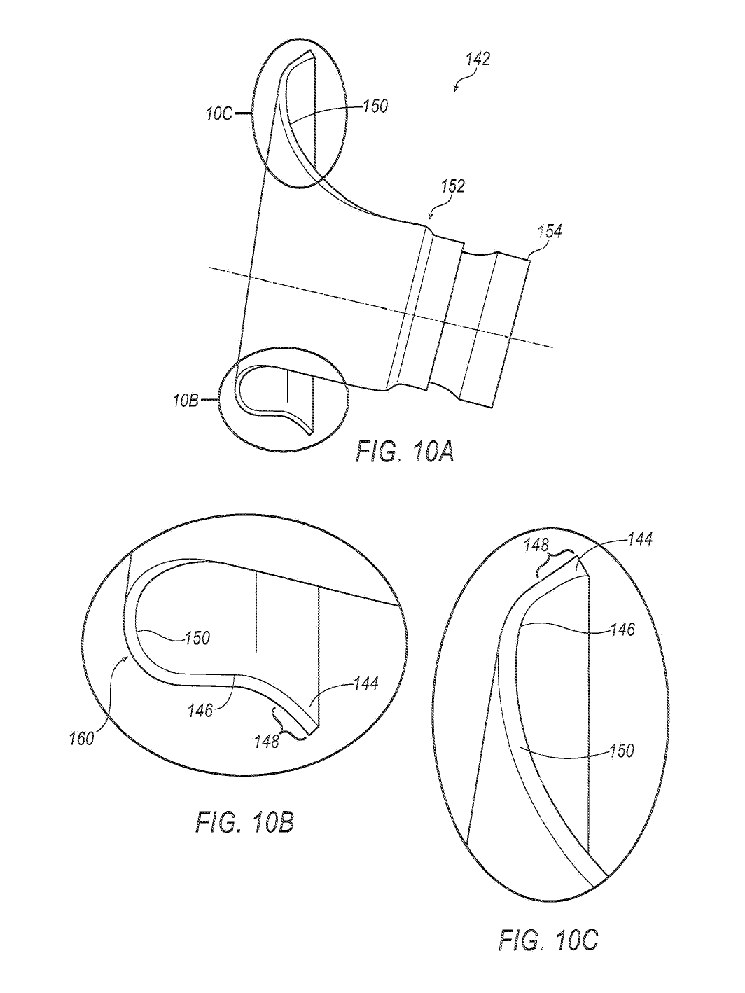

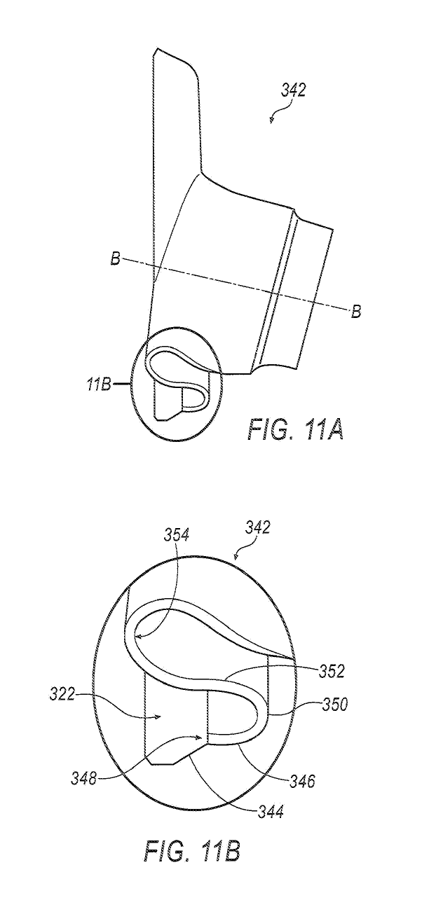

Additionally, in FIGS. 10A-11B exemplary flexible members 142, 342, are illustrated articulated at the 15° down angle. As illustrated, the flexible members 142, 342 expand and contract as the articulation changes during operation. Specifically, when the shaft 92B is angled down, the flexible member 142, 342 compresses at an area below the shaft (shown in FIGS. 10B and 11B) and the area above the shaft extends or stretches (shown in FIG. 10C). The flexible members 142, 242 and 342 are resilient enough to last the entire lifetime of the HACVJ 60 without becoming prematurely fatigued or damaged.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A constant velocity joint comprising:
an outer joint member defined by inner and outer surfaces;
an inner joint member having an outer surface, wherein the inner surface of the outer joint member and the outer surface of the inner joint define at least one of a front track and a rear track for a joint articulation in the range of approximately 10° to 30° with a continuous operating angle range of approximately 0° to 30°, a jounce angle range of approximately 15° to 30°, and an installation angle range of approximately 0° to 35°;
a cage defined by an inner surface and an outer surface, the cage being disposed between the outer joint member and the inner joint member and positioned adjacent to at least one of the front track and the rear track;
a plurality of torque transmitting balls arranged within the cage and contacting at least one of the front track and the rear track; and
a high angle flared sealing member secured to the outer surface of the outer joint member and providing a fluid bather to the inner surface of the outer joint member.

2. The joint of claim 1, further comprising at least one of a front track length of approximately 18.5 mm to 22.5 mm, a front track wrap angle of approximately 16 ° to 19.5°, a rear track length of approximately 30 mm to 34 mm, and a rear track wrap angle of approximately 30 ° to 34°

3. The joint of claim 1, wherein the articulation includes an operating angle of approximately 15° and at least one of a full suspension jounce articulation angle and an installation angle that is approximately 26°.

4. The joint of claim 1, wherein the sealing member includes an angle stop.

5. The joint of claim 1, wherein the sealing member includes a rigid member and a flexible member fused to the rigid member.

6. The joint of claim 1, wherein the inner joint member includes a shaft having a first end directly contacting the inner joint member and a second end directly adjacent the sealing member.

7. The joint of claim 5, wherein the rigid member includes a first sealing portion that is at least one of pressed, adhered and slid onto the outer joint member, a second sealing portion that is adhered to the flexible sealing member, and wherein at least one of the connections at the first sealing portion and the second sealing portion is fluid tight.

8. The joint of claim 5, wherein the flared outer portion of the rigid member extends outward.

9. The joint of claim 5, wherein the flexible sealing member is fused to the flared outer portion of the rigid member.

10. The joint of claim 5, wherein the rigid member includes an angle stop, and wherein the angle stop prevents the torque transmitting balls from over articulating.

11. The joint of claim 8, wherein the flared outer portion is at least one of an inwardly extending flare and an outwardly extending flare.

12. The joint of claim 6, wherein the sealing member is positioned directly adjacent the cage and is at least one of approximately 65 mm and approximately 69 mm from the second end of the shaft, and approximately 1.95 mm from at least one of the cage, the torque transmitting balls and the inner race.

13. The joint of claim 6, wherein the sealing member is positioned directly adjacent the cage and is approximately 1.5 mm to approximately 2.0 mm from at least one of the cage, the torque transmitting balls and the inner race.

14. The joint of claim 5, wherein the rigid member is both angled inwardly and angled outwardly, wherein the flexible member is attached directly to a transition point of the inward angle and the outward and is further attached directly to the outwardly angled portion.

15. A constant velocity joint comprising:
an outer race defined by inner and outer surfaces, wherein the inner surface defines a cavity defined by a plurality of counter tracks, wherein the counter tracks alternate between a front track and a rear track;
an inner race having a centrally located shaft, wherein the inner race is disposed within the cavity of the outer race, the inner race is defined by an outer surface, and wherein the inner race outer surface further includes a plurality of counter tracks corresponding to the outer race cavity counter tracks;
a cage disposed between the inner race and the outer race, wherein the cage includes articulation clearance for a plurality of torque transmitting balls, and wherein the plurality of balls are arranged within the cage and contacting at least one of the front track and the rear track of at least one of the inner and the outer race; and
a high angle flanged sealing member, wherein the flange is extending at least one of outwardly from the shaft or inwardly toward the shaft
wherein the interaction between the tracks provides an articulation with at least one of a continuous operating angle range of approximately 0° to 35°, a jounce angle of approximately 26°, and an installation angle range of approximately 0° to 35°.

16. The constant velocity joint of claim 15, wherein the sealing member includes a rigid member and a flexible member, and wherein the sealing member is sealingly secured to at least one of the outer race outer surface and the inner race shaft.

17. The constant velocity joint of claim 15, further comprising a fluid gap between the inner race and the sealing member.

18. The constant velocity joint of claim 15, wherein at least a portion of the sealing member is positioned directly adjacent the cage and is at least one of approximately 65 mm and approximately 69 mm from the second end of the shaft, and approximately 1.95 mm from at least one of the cage, the torque transmitting balls and the inner race.

19. The constant velocity joint of claim 15, wherein at least a portion of the sealing member is positioned directly adjacent the cage and is approximately 1.5 mm to approximately 2.0 mm from at least one of the cage, the torque transmitting balls and the inner race.

20. The constant velocity joint of claim 16, wherein the flexible member articulation includes a running angle of approximately 15° and at least one of a full suspension jounce articulation angle and an installation angle that is approximately 26°.

21. The constant velocity joint of claim 16, wherein the rigid member includes an angle stop, and wherein the angle stop prevents the torque transmitting balls from over articulating.

22. The constant velocity joint of claim 16, wherein the rigid member is at least one of angled outwardly, angled inwardly and both angled inwardly and angled outwardly, wherein the flexible member is attached directly to a transition point of the inward angle and the outward and is further attached directly to the outwardly angled portion.
